(19) United States
(12) Patent Application Publication
(10) Pub. No.: US 2017/0326826 A1
(43) Pub. Date: Nov. 16, 2017

(54) METHOD AND EQUIPMENT FOR ASSEMBLING A TIRE BLANK

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: HENRI HINC, Clermont-Ferrand (FR); CHRISTIAN BEAUDONNET, Clermont-Ferrand (FR); ALAIN FAUGERAS, Clermont-Ferrand (FR); PHILIPPE BOURNERIE, Clermont-Ferrand (FR); JEAN-MARIE DETTORRE, Clermont-Ferrand (FR)

(21) Appl. No.: 15/535,317

(22) PCT Filed: Dec. 21, 2015
(86) PCT No.: PCT/EP2015/080882

§ 371 Date: Jun. 12, 2017

(30) Foreign Application Priority Data
Dec. 19, 2014 (FR) 1463030

(51) Int. Cl. B29D 30/32; B29D 30/24; B29D 30/48

(52) U.S. Cl. CPC B29D 30/32; B29D 30/248; B29D 2030/3214; B29D 2030/487; B29D 2030/3264

(57) ABSTRACT

A method for assembling a green tire blank includes, in succession, laying rubber plies on a drum having segments that are radially moveable, with respect to a main axis, between expanded and collapsed positions; laying bead wires; lifting up edges of the plies that extend axially beyond the bead wires towards ends of the drum using wings that extend axially and that are arranged circumferentially around the main axis; and folding the edges of the plies using rollers. The segments form an external circumferential face of the drum. The rollers are independent of the drum and move in an axial direction on the circumferential face of the drum in order to turn the edges of the plies around the bead wire. The wings move in longitudinal cuts that run parallel to the main axis at ends of the segments in order to lift up the edges of the plies.

The invention relates to the field of the manufacture of tires for passenger or utility vehicles and is more particularly concerned with the tire building methods and equipment that allow the collection of constituent parts of such a tire to be laid in succession in order efficiently to arrive at a green tire that is ready to be cured.

In the various methods and equipment, all of the operations of building the green tire are performed on a drum the diameter of which preferably corresponds substantially to the interior diameter of the tire (commonly referred to as the “seat diameter” with reference to the standardized diameter of the rim on which the tire will be mounted when used). Thus, not only the carcass, the beads and the sidewalls, but also the crown reinforcers and the tread may be laid onto a tire building drum the diameter of which corresponds substantially to the seat diameter. One advantage of this type of method is that it allows the green tire to be kept on the same drum throughout the process of assembling it. The complete green tire can then be introduced directly into a curing press where it adopts its final external diameter through the action of an internal pressure. One example of this type of method is given in document FR1508652.

Shaping is the name given to the conversion that the green tire blank experiences as it passes from its substantially tubular shape to the generally toroidal shape of a finished tire. During shaping, the central part of the green tire which corresponds to the crown of the tire sees an increase in diameter through the action of an internal pressure, while the beads are kept at the initial diameter. The difference in circumference between the seat diameter and the shaped diameter is generally comprised between 30% and 70%, and for example, commonly of the order of 50% for a passenger vehicle tire.

When it does not take place within the curing press, the operation of shaping the green tire is performed on a tire building drum. Thus methods and equipment referred to as “single-stage” are known, and in these the shaping of the green tire is performed on a single drum. In methods and installations of another type known by the name of “two-stage”, the carcass is manufactured on a first drum with a diameter suited to the seat diameter, and is then transferred onto a second, shaping, drum where it receives the crown unit assembled beforehand on a crown form. The green tire blank obtained at a diameter close to the final diameter of the tire is then introduced into the curing press.

In these various methods and equipment for the manufacture of tires, the tooling is designed according to the architecture of the tire which imposes the order of assembly of the various products that make up the green tire, according to the seat diameter of the tire and also according to the distance separating the two bead wires. As a result, for a range of, for example, passenger vehicle tires, it is necessary to design and produce a plurality of drums, it being necessary to load and set up the various drums on the tire building machine according to the characteristics of the tire that is to be manufactured. One alternative solution is to use a complex drum, as is generally known, but which nonetheless remains suited to the manufacture of green tire blanks within a pre-established range of seat diameters and a pre-established range of distances between the bead wires.

Moreover, after the bead wires have been laid, the ends or edges of the rubber plies that are involved in the makeup of the green tire and are laid beforehand onto the drum, notably the carcass ply, need to be turned around the bead wires. To do that, the drum needs to be provided with ply-turning devices which, for the most part, are equipped with inflatable bladders mounted fixedly on the drum. When these are inflated, they turn the ends of the plies over the bead wires. Such a bladder-type ply-turning device is complex and expensive, especially since it is tailored to a particular size of tire and proves to be tricky to maintain. What is more, a ply-turning device of the inflatable bladder type is unable to correctly fold green tire components of which the length of the ends to be folded over exhibits variations after laying or else when the ends that are to be folded are too rigid, for example when turning a metallic carcass ply.

Ply-turning devices comprising mechanical systems free of an inflatable bladder are also known. Such an example is the ply-turning device of document U.S. Pat. No. 3,887,423, the drum of which comprises a plurality of circumferential fingers mounted with the ability to pivot about an axis perpendicular to the axis of rotation of the drum, and also having the possibility of moving in translation parallel to the axis of the drum. This system has the disadvantage of being mounted on the drum and, therefore, of being restricted to one size of tire. What is more, it is not suitable for use with a multi-workstation tire building machine, the drum then being bulky and expensive.

In order to alleviate this problem, the ply-turning device may be arranged on the outside of the drum. Such a device is described in document U.S. Pat. No. 4,362,592 and is suited to use with an automatic tire-building machine having several tire-building workstations. The device comprises two ply-turning assemblies each comprising several circumferential fingers and arranged near the axial ends of the drum. The end of the fingers of each assembly comprises rollers and the fingers are actuated, by means of a hydraulic actuating cylinder and a cam mechanism, to move radially and axially with respect to the drum so as to lift up the end of the carcass ply and then fold it over the bead wires. While being easier to maintain and admittedly allowing a movement of greater amplitude to be developed than can be achieved with the preceding devices, its use is nevertheless limited to a given architecture of tire and to the presence of just one ply to be turned, the length of which is greater than that of the drum.

Thus, with requirements imposed by the assembling of a complex product, the tire industry is dependent on there being a stock of drums of greater or lesser complexity that need to be stored, mounted on a tire building machine or replaced and set up when starting a tire or series of tires of a given range. That entails high manufacturing costs and long cycle times.

It is therefore an objective of the invention to alleviate at least one of the disadvantages described hereinabove.

For that purpose, the invention proposes a method and an equipment that allow the laying of the various components of a green tire blank, namely the components of a carcass or of a complete green tire, on a simplified expandable drum. Carcass is the name used to denote that part of the green tire that does not comprise the crown unit.

The invention therefore proposes a method of assembling a green tire, comprising in succession steps involving:
laying rubber plies on a drum made up of segments that are radially mobile between a drum-expanded and a drum-collapsed position, which segments form the external circumferential face of the drum of main axis,
laying bead wires,
lifting up the edges of the plies extending axially beyond the bead wires towards the ends of the drum using wings extending axially and arranged circumferentially around the main axis,
folding the edges of the plies using elements involving rollers which elements are independent of the drum and move in the axial direction on the circumferential face of the drum in order to turn the edges of the plies around the bead wire,
in which the said wings are moved in longitudinal cuts running parallel to the axis at the ends of the segments in order to lift up the edges of the rubber plies that are laid on the drum before they are folded.

Thus, according to the invention, it becomes possible to lay on a drum that can be expanded in terms of diameter one or more component(s) of the green tire (inner liner, carcass ply, protectors in the form of strips of rubber, etc.) in the desired order, it being possible for the various products to be secured to one another by rollering over their entire length by applying pressure to the external circumferential face of the drum. Once the bead wires have been laid on the drum, the ends of the various products laid on the drum are lifted up using the wings, then folded using the elements involving rollers. Because the drum segments are slotted, the wings can lift up several products laid on the drum and supported thereby, notably with a view to rollering. What is more, because the device for folding or turning the plies around the bead wires has been made independent of the drum, it can be used for turning the edges of the plies around the bead wires while at the same adapting to accommodate a plurality of distances between the bead wires. As a result, the drum lends itself to the building of a plurality of tire sizes.

What is more, the edges lifted up and turned over according to the method of the invention may comprise several plies stuck together, it being possible for the plies each to comprise textile or metallic reinforcers. The wings of the device of the invention are rigid and robust enough to be able to lift a complex of plies with a view to ply-turning by a device independent of the drum. The drum and the associated devices in the context of the method of the invention can therefore be used to create tires of different architectures (the architecture being defined by the arrangement and composition of the collection of plies that make up the green tire) in addition to the possibility offered by this method of varying their size, thus further increasing the number of manufacturing options offered by the tire building method of the invention. It thus becomes possible to propose a tire building method according to the invention which is highly flexible and adapts to various manufacturing requirements.

For preference, the various components that are to be assembled are laid on a drum free of grooves. This makes it possible to sever the connection with distance between bead wires and therefore, since the drum is also expandable in terms of diameter, to build several sizes of tire on the one same drum, for example by laying the bead wires using the arm of a robot at a pre-established location on the drum.

For preference also, the bead wires are formed by winding a metal cord onto the drum. That makes it possible to form a bead wire in situ and, through a suitable choice of the number of turns to be wound, better adapt the bead wire to suit the tire that is to be built.

For preference also, the laying of at least one first product begins at a diameter smaller than that of the seat. That allows tension to be introduced into the first product or products laid on the drum, which is then inflated to the seat diameter which corresponds to the laying of the reference products including the bead wires.

In one advantageous embodiment of the invention, a wavy strip is wound in a helix on the green tire in order, in a plurality of turns, to form a tire crown hooping ply, the wavy strip having a given over length to allow the green tire to be shaped. This allows all the components of the green tire to be built up, flat, on the one same drum before the tire is shaped.

For preference, all the components of the crown unit are laid and the green tire is finalized before the drum is collapsed. At least one wavy reinforcing strip is thus laid by winding around the drum, as well as at least one metal reinforcing ply, the tread and the sidewalls in order to obtain a green tire that can be shaped directly in a curing press. The drum is then collapsed so that the green tire can be extracted and sent for curing.

The invention also proposes an equipment for implementing such a method, the said equipment comprising a drum driven in rotation about a main axis, the said drum being able to support a green tire blank created by the successive laying of raw components on the external circumferential face of the drum which face is made up of segments which are radially mobile between a drum-expanded and a drum-collapsed position, the said drum being positioned facing a ply-turning device independent of the drum, the said device being able to turn the edges of the rubber plies laid on the drum around a bead wire using elements involving rollers which are mounted with the ability to move in the axial direction on the circumferential face of the drum, in which each end of segment comprises a longitudinal cut running parallel to the axis, the cut being made to collaborate with a wing which runs parallel to the axis and is made to move in the said cut in order to lift up the edges of the rubber plies extending axially beyond the bead wires towards the ends of the drum so that they can be turned over.

The equipment of the invention makes it possible to optimize the functions of each device of which it is composed and also the functionality of these devices as a whole so that it is flexible and suited to the building of a plurality of green tires in terms of dimensions and architectures of tire to be manufactured.

For preference, the equipment comprises an expandable drum free of grooves.

For preference also, the said wings are mounted on a lifting device comprising drive means able to move the wings in an axial direction and/or in a radial direction.

For preference also, the said lifting device is independent of the drum.

For preference also, the said ply-turning device comprises a plurality of circumferential articulated arms comprising the rollers, the said arms being mounted with the ability to move radially and axially with respect to the drum.

For preference also, the elements involving rollers and the wings are mounted on a common support able to move in longitudinal translation with respect to the drum and secured to the drive means designed to move the elements involving rollers and the wings in the same direction, but with a temporal offset.

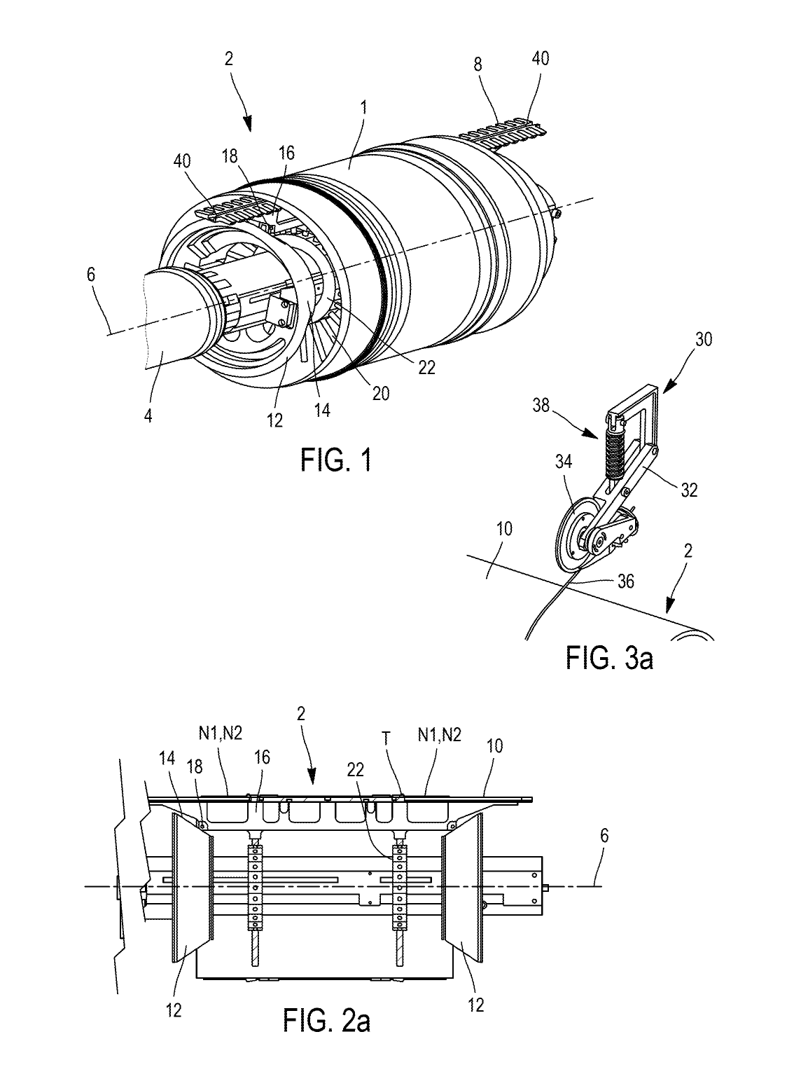

The following description allows a better understanding of the method according to the invention and of the structure and operation of an equipment according to preferred embodiments of the invention, and is supported by FIGS. 1 to 12 in which:

FIG. 1 is a perspective view of a drum according to one embodiment of the invention, just one segment being depicted for supporting the green tire,

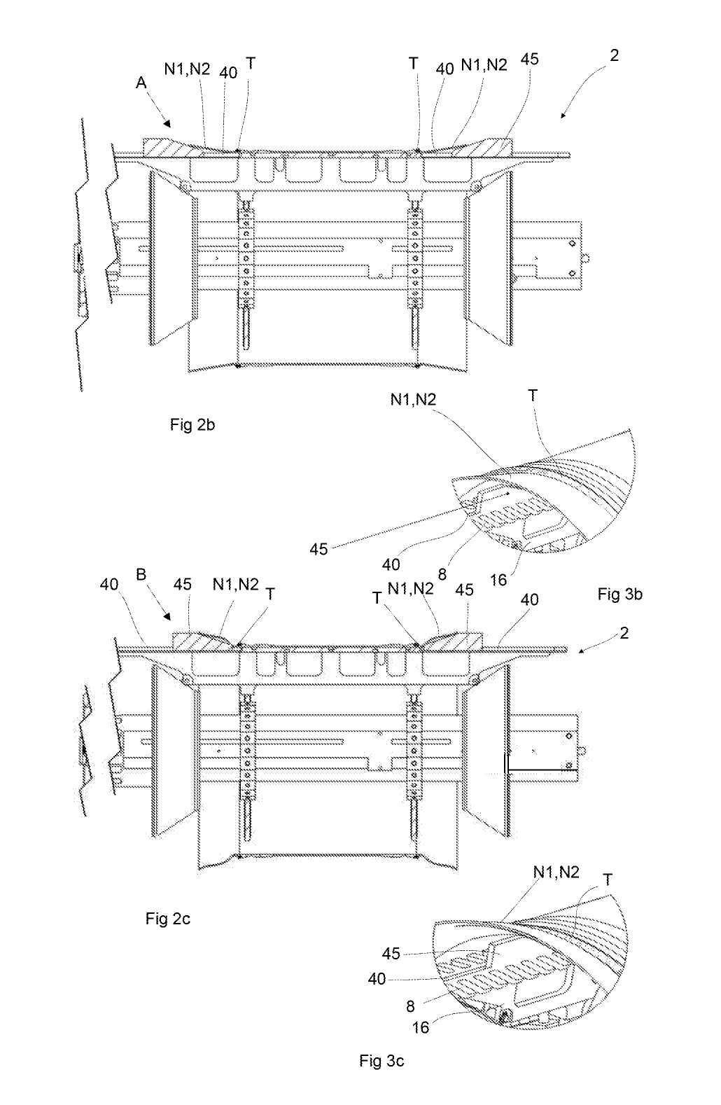

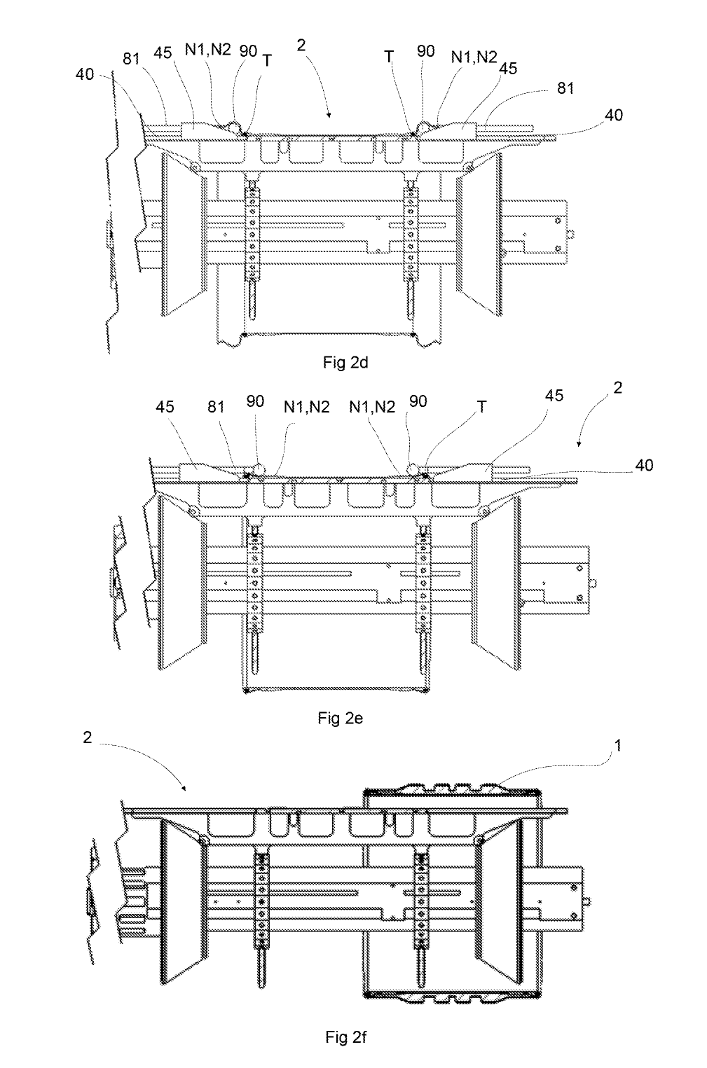

FIGS. 2a to 2f are schematic views in cross section of the drum of FIG. 1 illustrating the various stages in the method of the invention,

FIGS. 3a to 3c are perspective views illustrating details of the various devices of the equipment in action during the various stages of the method of the invention,

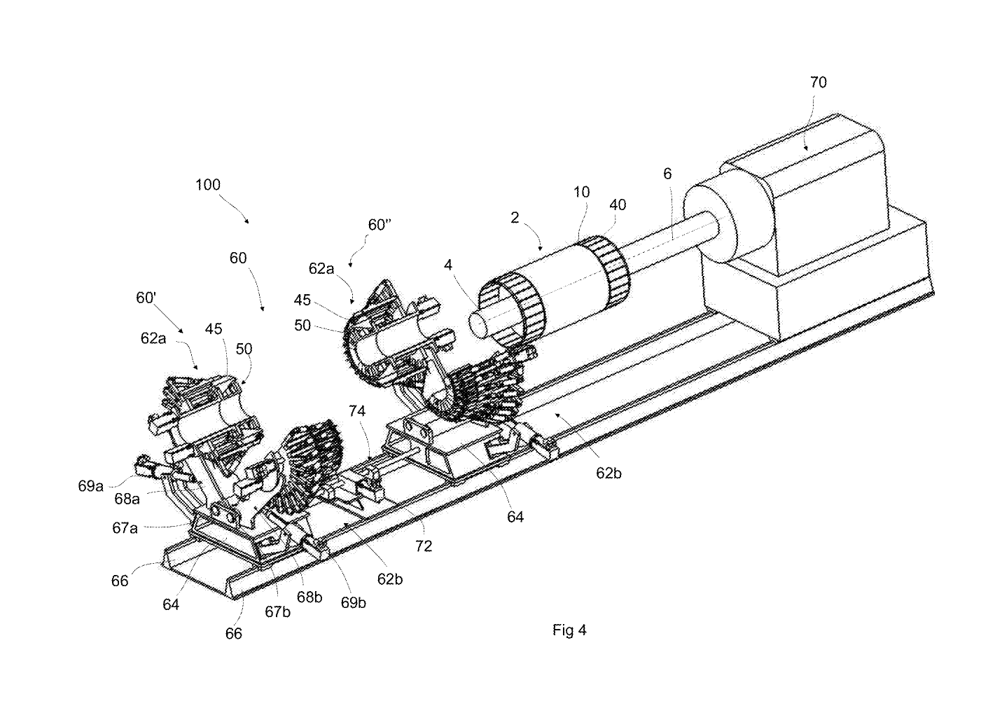

FIG. 4 is a perspective view of one exemplary embodiment of the equipment of the invention using the drum of FIG. 1, the drum being set apart from the ply-turning device,

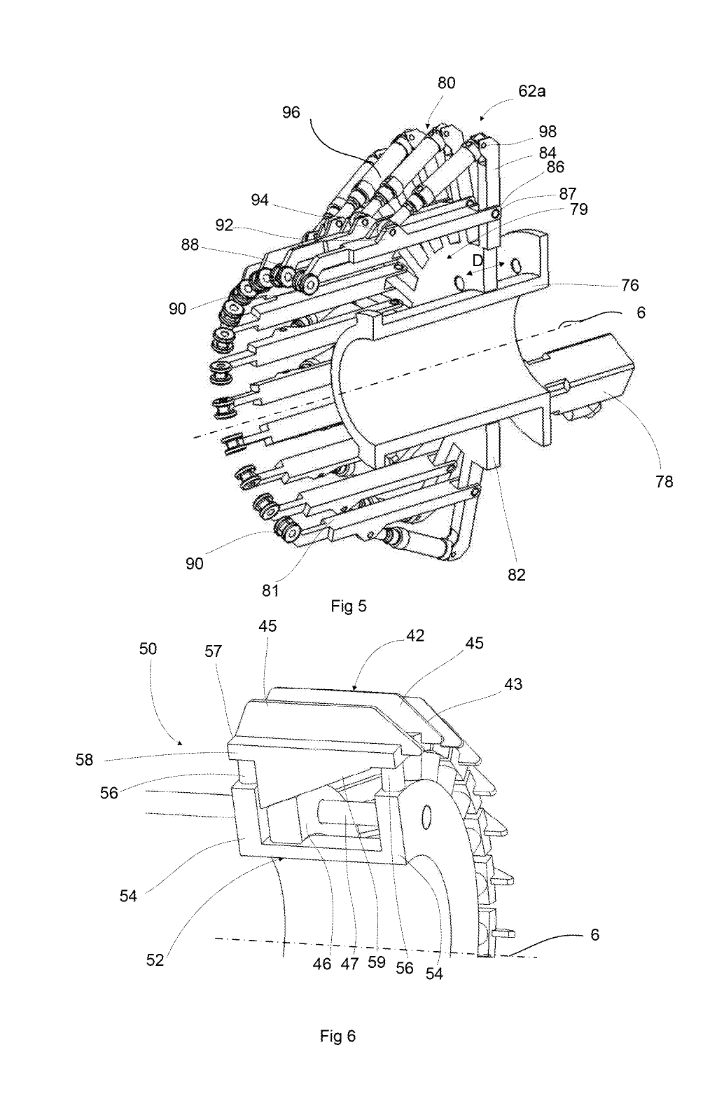

FIG. 5 is a perspective view of a ply-turning segment of the equipment of FIG. 4 prior to the ply-turning stage of the method of the invention,

FIG. 6 is a perspective view of a lifting device of the equipment of FIG. 4,

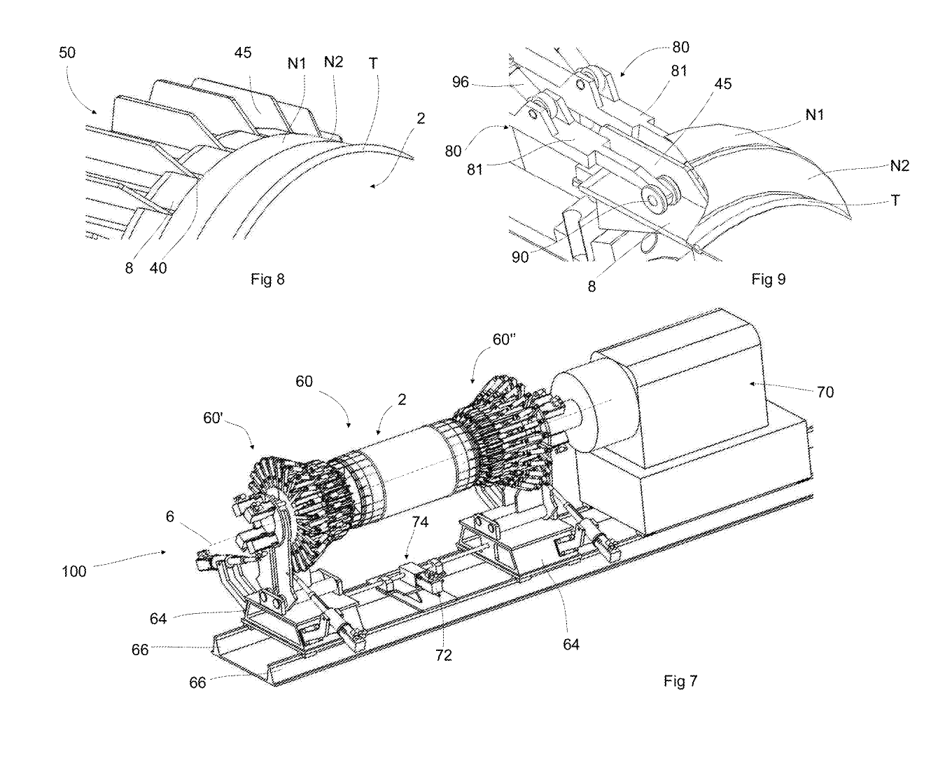

FIG. 7 is a perspective view of the equipment of FIG. 4, with the drum being connected to the ply-turning device,

FIGS. 8 to 11 are perspective illustrations of the various components of the equipment during the ply-turning operation.

In the various figures, the elements that are identical or similar bear the same references. The description of the structure and of the function of these identical or similar elements is therefore not systematically repeated.

FIG. 1 shows a drum 2 according to one embodiment of the invention. This drum is used for building up the components that form a green tire for a passenger vehicle or a utility vehicle. The drum 2 comprises a central support or shaft 4 and has an overall shape exhibiting symmetry of revolution of axis 6 which forms the main axis of the drum. In what follows, axial or longitudinal means a direction parallel to the axis 6 of the drum and radial means a radial direction, perpendicular to the latter.

The drum 6 has external segments 8 or tiles which run around the periphery of the drum to form the external circumferential face 10 of the drum which defines the working face on which the components of the green tire are arranged. This face has a cylindrical overall shape of circular cross section in a plane perpendicular to the axis 6. This face allows the various components of the green tire to be laid “flat”. The segments 8 are all identical to one another, are arranged in the circumferential direction of the drum and, in this particular example, there are 24 of them, although this number may vary. In this example, each segment is rigid and formed of a single piece having the overall shape of a comb. The segment 8 has a rectangular overall shape of length (which means longest direction) parallel to the axis 6 and the longitudinal edges of which are cut to form toothings so that the teeth of the edge of one comb can imbricate with the teeth of the edge of the adjacent comb. Because the segments are able to move in a radial direction with respect to the axis 6, the comb shape of the segments means that their distance from the axis can be varied while at the same time ensuring a certain continuity of material between the combs in the circumferential direction of the drum.

The segments 8 are connected to the drum by members which guide and drive them. In the example illustrated in the figures, these members comprise two cams 12 centred on the axis 6 of the drum and each having two lateral faces perpendicular to the axis 6 between them delimiting a conical surface 14. The cams 12 are identical and are arranged as a mirror image of one another about a central mid-plane of the drum perpendicular to the axis 6 thereof, one in the right-hand part and the other in the left-hand part of the drum and with the possibility for axial movement. Each segment 8 is fixed rigidly to a segment support 16. In the example depicted, there are 24 of these supports 16 although the number of them may vary. The support 16 has an elongate shape in a direction parallel to the axis 6 and near each end has a follower 18 which follows the inclined circumferential surface 14 of the cam 12. Each support 16 is connected by two rigid rods 20 to a ring 22 centred on the axis 6 of the drum mounted with the ability to rotate with the latter. The rods 20 slide in radial openings made for this purpose within the ring 22 and radially guide the segments 8. The segments are kept in contact with the cams by means of an elastic means (not illustrated), for example a flexible bladder. The cams are driven in an axial movement that is symmetric on each side of the mid-plane of the drum, for example by connecting them to a mechanism of the screw-nut type, one of the ends of the screw having a right-hand thread and the other a left-hand thread, and the screw being turned with the drum 2. The cams 12, the supports 16, the rods 20 and the rings 22 form means of expanding/collapsing the drum 2. In order to move the drum from the collapsed position into the expanded position, the cams 12 are made to move axially in the direction that brings them closer together, something which occurs symmetrically with respect to the mid-plane of the drum and along the axis 6. This movement causes the support 16 and therefore the segment 8 to slide radially in the direction perpendicular to the axis 6. This movement is the same and takes place simultaneously for all the segments 8 of the drum, which means that the drum 2 maintains its cylindrical shape during all the changes in diameter of the drum.

The drum components are made of metal, or of material most being made of steel or of aluminium, the surface of the segments 8 that is in contact with the rubber being treated according to the operating conditions (for example in order to make it sticky or non-sticky towards the rubber). In an alternative, certain components may be made of a plastic or composite material for greater rigidity.

Other segment drive systems for making the transition from the collapsed position to the expanded position and vice versa may be envisaged, such as electric or hydraulic actuating cylinders that move the cams axially, or even rotary cams with grooves in which followers connected to the segments run, etc.

According to one advantageous feature of the invention, the drum 2 has an external circumferential face 10 of cylindrical overall shape free of bead wire-housing grooves. When used to build passenger or utility vehicle green tires, the drum of the invention preferably has a diameter greater than 250 mm and a length greater than 700 mm or, more generally, the length/diameter ratio for the drum needs to be greater than 2.5.

Such a drum not only allows the building of green tires in a broad range of seat diameters but also, because of the absence of grooves, in a broad range of dimensions of the space between bead wires (which means the distance separating the two bead wires during the building of the green tire). The bead wires are then laid in a precise position on the drum using a robot-controlled arm or are produced in situ during the laying on the drum.

FIG. 3a illustrates a device 30 for winding a bead wire cord 36 onto the external circumferential face 10 of the drum 2, the latter already being covered with rubber components of the green tire, for example one or more plies, rubber strips, etc. as will be explained hereinafter. The winding device 30 comprises a support 32 mounted with the ability to move radially and axially with respect to the drum, and carrying a reel 34 of bead wire cord 36, preferably a metal cord sheathed with rubber, together with a means 38 of tensioning the cord 36. The support is brought into an axial and radial position with respect to the drum 2 and the reel 34 is set in rotation by a motor (not depicted) so as to wind the cord 36 at a given tension onto the drum, several turns thus being performed according to the type and size of tire. The structure of the bead wire thus obtained is in the form of a number of contiguous turns in one or a number of superposed layers. For better stability of the assembly that forms the bead wire, the winding of the top layer is preferably offset by a distance equal to the radius of the cord and comprises a lower number of turns than the base layer. By way of example, for a tire with a seat diameter of between 14 and 16″, the number of turns is preferably between 5 and 20, for a lay in two or three layers using a cord with a metal wire diameter of around 1.5 mm.

For the next operations, the drum 6 collaborates with a ply-turning device 60 which is independent of the drum and which folds the ends of the components of the carcass around the bead wires and presses them down with a roller.

More particularly according to the invention, the drum has several longitudinal cuts 40 which are slots uniformly distributed on its circumference and are there to collaborate with mobile wings 45 which are designed to be able to move with respect to the cuts 40 so as to be able to lift up the longitudinal edges of the green tire 1 so that they can be turned around the bead wires. The cuts 40 are longitudinal slits made in the centre of each segment 8, over a pre-established distance at each of the longitudinal ends of a segment. The length of a slit is preferably less than one quarter of the length of a segment 8. The slits may or may not be open-ended, depending on how the wings move, and they all have the same width.

In one embodiment of the invention and as is better visible in FIG. 6, the wings 45 constitute the projecting elements of a lifting device 50. The role of the lifting device 50 is to move the wings 45 in order to achieve a change in level in the radial direction of at least one point of their projecting part. The lifting device 50 comprises an annular support 52 centred with respect to the axis 6 of the drum. The cross section of the annular support 52 is U-shaped with the branches of the U made up of two lateral flanges 54 with faces perpendicular to the axis 6. The flanges 54 comprise a plurality of orifices arranged radially and forming guide bearings for radial support rods 56 of the members 58 arranged on the circumference of the support 52. The member 58 comprises a substantially planar external face 57 supporting a wing 45 which is mounted for example by force in a longitudinal slot of this face. Several wings 45 are mounted in this way; in the example illustrated there are 24 of them, these being uniformly distributed about the circumference of the annular support 52. The member 58 also comprises a conical internal face 59 coming into contact with a conical ring 46 centred on the axis 6, for example under the force of a spring (not visible in the drawings). The conical ring 46 is mounted with the possibility of moving in longitudinal translation on bars 47 held by the flanges 54. The translation movement of the conical ring 46 is performed with a view to adjusting the radial position of the wings 45 and is obtained for example by means of a screw (formed for example by the bar 47) and nut (formed for example by a threaded orifice in the conical ring 46) device. The radial position is adjusted simultaneously for all the wings 45 and allows the diameter of the external circumferential face 42 of the lifting device 50 to be adapted to the diameter of the expanding drum 6.

In the example depicted in the figures, the wings 45 have a flat overall shape of trapezoidal profile and comprise a leading edge part oriented in the direction of the drum 6 which has an inclined edge 43 forming an angle of between 30 and 45° with the axial direction. The wings are identical and uniformly circumferentially distributed. The thickness of a wing 45 is less than that of a cut 40 so that the wing can move in the cut. This angle is chosen so as to be able to lift up the edges of the plies in such a way that the edges can be driven by the rollers of the ply-turning device. According to the invention also, the wings 45 are mounted with the ability to move axially and/or radially. To this end, use is made of a first actuator such as, for example, an electric actuating cylinder which moves the support 52 in longitudinal translation alone, or in combination with an actuator which moves the conical ring 46 in longitudinal translation.

In the example depicted in the figures, the lifting device 50 is incorporated into the ply-turning device 60 which is independent of the roller, as will be explained hereinafter. However, in an alternative form of embodiment (not depicted) of the invention, the lifting device may be mounted on the drum 6, being arranged with its actuators at the ends and on the inside thereof. In an exemplary embodiment which is not depicted in the figures, when the device is incorporated into the drum, the wings 45 are replaced by rods which project through the cuts 40 to the outside of the drum, beyond the bead wires. These rods are then made to move axially to get into position and radially to lift the edges of the components, it being possible for these two movements either to be combined or separate.

The structure and operation of the ply-turning device 60 will now be explained with reference to FIGS. 4 and 5. The ply-turning device 60 comprises two identical ply-turning heads 60′, 60″ mounted on a common support and each comprising a plurality of identical circumferential articulated arms 80 which are designed to collaborate with the external face 10 of the drum 2. In the example illustrated in the figures, the device 60 is designed to collaborate with a drum 6 in the context of an automatic machine having several tire-building workstations. The drum 6 which arrives at the ply-turning workstation in FIG. 4 already comprises the various rubber plies and the bead wires laid on the external circumferential face 10, the cuts 40 being visible beyond the longitudinal edges of the rubber plies. The ply-turning heads 60′, 60″ each comprise a support 64 mounted with the ability to slide longitudinally along guide rails 66 which also support the unit 70 that supports and drives the drum 6. Each ply-turning head is formed from two segments 62a and 62b each one mounted on a support 68a, 68b with the possibility of each pivoting about an axis 67a, 67b. The axes 67a, 67b are parallel to one another and parallel to the axis 6. When actuated by actuating cylinders 69a, 69b, the segments 62a, 62b open to allow the drum 6 to pass and then close again. The two supports 64 of the heads 60′, 60″ are driven in a movement of longitudinal translation along the guide rails 66 by an electric actuating cylinder 72, by means of a mechanism of the screw-nut type 74.

The members that connect the articulated arms 80 to the support and that guide and drive them will be introduced in what follows. A detailed description will be given of the members situated in the right-hand part of the drum in FIGS. 4 and 7, in the knowledge that the drum collaborates in the left-hand part with similar members extending symmetrically with respect to the first members about a mid-plane of symmetry perpendicular to the axis 6. The articulated arms 80 are supported by a flange 82 the faces of which are perpendicular to the axis 6, the flange being mounted with the ability to slide and centred on a tubular sleeve 76 itself centred on the axis 6 and designed to accept the shaft 4 of the drum 6. The flange 82 comprises a plurality of radial arms 84 uniformly distributed on its circumference, each radial arm 84 forming a support for an articulated arm 80. More particularly in the example depicted in the figures, the articulated arm 80 comprises a rigid body 81 the shape of which is elongated in the axial direction and comprises two ends: a mounting end 86 for mounting on a radial arm 84 and an active end 88 which is slightly radially inclined and comprises a pair of rollers 90 mounted with the freedom to rotate about an axis perpendicular to the longitudinal direction of the body 81. The articulated arm 88 is mounted with the possibility of pivoting with respect to the radial arm 84 about an articulation of axis 87 extending in a direction perpendicular to the axis 6. To actuate the articulated arm 80, an electric actuating cylinder 96 is mounted with the ability to pivot, about axes that are parallel to one another and perpendicular to the axis 6, between the external end of the radial arm 84 and the central part of the body 81. When actuated, the actuating cylinder 96 causes the active end 88 of the articulated arm 80 to move in a radial direction. The flange 82 is also connected to an electric actuating cylinder 78 which, by means of a screw and nut mechanism (not illustrated) causes its longitudinal translational movement in the direction of the arrows D in FIG. 5. In operation, when the actuating cylinders 96 are actuated, they cause the rollers 90 to move closer to and come into contact with the circumferential external face 10 of the drum 6, the movement of the flange 82 allowing a longitudinal translational movement of the rollers on the drum, according to a sequencing that will be explained later on.

The equipment 100 of the invention is illustrated in FIG. 7 with the various components ready to perform their assigned operations, notably the drum being brought into position to collaborate with the ply-turning device 60. For that purpose, the drum 2 has been aligned with the ply-turning heads 60′ and 60″, and it will be appreciated that the angular position of the segments comprised in the mid-plane of the drum has been adjusted to concord with that of the articulated arms 80 situated in the same plane. Specifically, as is better visible in FIG. 8, the wings 45 of the lifting device 50 need to be positioned facing the longitudinal cuts 40 of the drum 2, the articulated arms 80 of the ply-turning device 60 themselves being positioned on either side of each wing 45 (FIG. 9). In order to perform the alignment use is made for example of an optical sensor on the drum and of optical reader means on the heads 60′, 60″ (or vice versa), or even of a sensor of the absolute rotary encoder type connected to the rotor of the motor that drives the rotation of the drum.

In order to perform good ply turning, and as is better visible in FIG. 9, two articulated arms 80 act one on each side of a wing 45. Each ply-turning head 60′, 60″ thus comprises twice as many articulated arms 80 as there are longitudinal cuts 40 or as there are segments 8 present on the drum 2. Moreover, in the embodiment illustrated in the figures, a lifting device 50 is incorporated into each ply-turning head 60′, 60″ and therefore an annular space 79 is created to accept a lifting device 50 in the forward part (facing the drum) of each ply-turning head 60′, 60″ (FIG. 4 et FIG. 5). The lifting device 50 is mounted fixedly on the tubular sleeve 76 and moves with the latter.

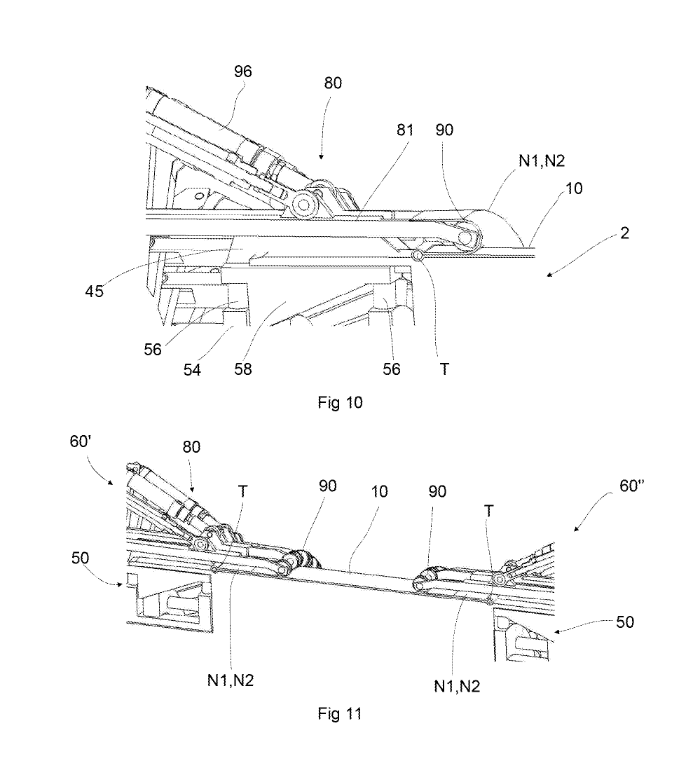

The operation of the equipment 100 of the invention will be described in what follows. The drum 2 comes into the vicinity of the ply-turning workstation of the tire building machine, as visible in FIG. 4, the segments 62a and 62b of the ply-turning heads 60′, 60″ being parted in order to allow the drum 2 to pass through the head 60″. In the example illustrated, in the same way as the ply-turning heads on which it is mounted, the lifting device is likewise produced in the form of two segments that are identical and symmetric with respect to a vertical plane passing through the axis 6. Once the drum 2 is in position mid-way between the two ply-turning heads, the segments 62a, 62b close up around the shaft 4 of the drum 2. The drum 2 is then rotated to align it or correctly angularly position it with respect to the articulated arms of the ply-turning heads, this position being illustrated in FIG. 7. Next, the ply-turning heads 60′, 60″ are moved in longitudinal translation towards one another simultaneously and symmetrically with the aid of the actuating cylinder 72 and the screw-nut system 74 so as to bring the lifting device 50 up close to the drum 2. The diameter of the adjusting device is adjusted as explained previously to the diameter of the drum 2. The wings 45 of the device 50 are then moved in the longitudinal cuts 40 of the drum 2 to come into contact with the longitudinal edges of various rubber-based plies laid thereon. This action of the wings 45 is better visible in FIG. 8, these wings being on the point of accosting the edge of a first rubber ply N1 (for example a rubber known as a chaffer) situated underneath a second ply N2 (for example a carcass ply) which itself supports the bead wire T. Because of the leading edge profile of the wings 45, the edges of the plies N1, N2 slide along the edges of the wings 45 and begin to lift with respect to the bead wire T. The ply-turning heads 60′, 60″ are moved in longitudinal translation towards the drum 2, which means that the rollers 90 follow the wings and pass under the plies N1, N2. The wings preferably stop upon contact with the bead wires T, and the rollers 90 continue to advance in order to turn the plies. For preference, upon contact with the bead wire, the articulated arms 80 are parted radially by their actuators 86 so as to follow the contour of the bead wire T. Next, the articulated arms 80 retract radially so that the rollers 90 can advance applying pressure to the drum 2 to push the edges of the plies N1, N2 towards the centre of the drum 2 (FIG. 10). The rollers 90 are then moved over the drum 2, so that the pressure applied expels the air trapped between the plies during the ply-turning.

In an alternative form, the choice is made to move the rollers 90 over the external face of the drum without applying pressure, so as to facilitate the passage of the bead wires, and then to apply pressure to the turned-over edges of the plies in order to expel the air bubbles trapped between the plies.

FIG. 11 illustrates the end of the ply-turning operation. The rollers can now be made to part with respect to the drum by opening the arms radially and causing the ply-turning heads 60′, 60″ with the lifting devices 50 to retreat longitudinally, and then the segments 62a, 62b can be opened up to allow the drum 2 to be withdrawn. The drum can now return to another tire building workstation of the tire building machine.

Preferably before the drum is withdrawn, rollering means apply additional pressure by running over the turned-over plies or edges in order to finish expelling air and better bond these to the surface of the green tire.

FIGS. 2a to 2f show the essential stages in the method according to the invention.

FIG. 2a schematically illustrates the drum 2 at the start of tire building phase, its diameter being adjusted to the diameter that corresponds to that of the seat minus the thickness of the plies to be laid under the bead wire. In an alternative form, the diameter of the drum in this stage is slightly smaller if a certain amount of tension is to be applied to the first plies laid on the drum. One or more plies, preferably at least two plies N1, N2, are then laid and these plies are rollered over their entire length to press them firmly against one another and expel air. The bead wires T are then laid as explained previously.

In order to complete the building of the carcass of the green tire, the edges of the plies N1, N2 need to be turned around the bead wires T using the ply-turning device of the invention. The start of the ply-turning operation is illustrated in FIG. 2b where it is possible to see the wings 45 of the lifting device moving in the longitudinal cuts 40 of the drum to come into contact with the edges of the plies N1, N2 that they begin to lift. FIG. 3b illustrates on a larger scale a perspective view of detail A of FIG. 2b.

FIG. 2c illustrates the progression of the wings 45 along the cuts 40 of the drum 2, these wings stopping near the bead wires T to allow the action of the rollers 90 of the ply-turning device to take over (FIG. 2d). FIG. 2e illustrates the end of the ply-turning operation by the rollers 90, the edges of the plies N1, N2 being folded over at 180° with respect to their initial position around the bead wires T.

Other rubber-based plies can then be laid on the carcass thus formed, for example plies constituting the sidewalls, a wavy strip of reinforcer, a reinforcing ply and the tread so as to obtain a complete green tire blank 1. FIG. 2f illustrates the end of the operation of building the complete green tire blank 1 which can be removed by collapsing the drum 2. The green tire blank thus obtained is sent to the curing shop where it is introduced into a curing press, inside which the tire is shaped and cured.

Other alternative forms and embodiments of the invention can be envisaged without departing from the scope of these claims. Thus, the ply-turning device and the lifting device of the invention may be used with any other type of drum provided that it has cuts suited to collaborating with wings of the lifting device so as to allow the action of the rollers of the ply-turning device.

1-12. (canceled)

13. A method of assembling a green tire blank, the method comprising steps of:
laying rubber plies on a drum, wherein the drum is made up of segments that are radially moveable with respect to a main axis between a drum-expanded position and a drum-collapsed position, and wherein the segments form an external circumferential face of the drum;
laying bead wires;
after the laying of the plies and the laying of the bead wires, lifting up edges of the plies that extend axially beyond the bead wires towards ends of the drum using wings, wherein the wings extend axially and are arranged circumferentially around the main axis, and wherein the wings are moveable in longitudinal cuts that run parallel to the main axis at ends of the segments in order to lift up the edges of the plies; and,
after the lifting up of the edges of the plies, folding the edges of the plies using elements that include rollers in order to turn the edges of the plies around the bead wire, wherein the elements are independent of the drum and move in an axial direction on the circumferential face of the drum.

14. The method according to claim 13, wherein, in the laying of the plies, the drum is free of grooves when the plies are laid thereon.

15. The method according to claim 13, wherein the laying of the bead wires includes winding a metal cord directly onto the drum.

16. The method according to claim 13, further comprising a step of laying at least one product on the drum beginning at a diameter smaller than a seat diameter, to form a green tire.

17. The method according to claim 16, further comprising a step of winding a wavy strip in a helix on the green tire in a plurality of turns, to form a tire crown hooping ply, wherein the wavy strip has a given over-length to allow the green tire to be shaped.

18. The method according to claim 16, further comprising a step of collapsing the drum after laying all components of a crown unit and the green tire is finalized.

19. A tire-assembly equipment for assembling a green tire blank, the equipment comprising:
a drum that is rotatable about a main axis, the drum having an external circumferential face formed of a plurality of segments, each of the segments being moveable in a radial direction with respect to a main axis between an extended position and a collapsed position, the drum being structured to support a green tire blank during creation of the green tire blank by successive laying of raw components on the external circumferential face, the raw components including a plurality of rubber plies;
a ply-turning device positioned to face the drum, the ply-turning device being independent of the drum and including rollers arranged to turn edges of the rubber plies laid on the drum around a bead wire, the rollers being mounted on the ply-turning device such that the rollers are moveable in an axial direction on the circumferential face of the drum,
wherein each of the segments has ends, and each of the ends of the segments includes a longitudinal cut that runs parallel to the main axis, the cuts being structured to collaborate respectively with corresponding wings of the ply-turning device that run parallel to the main axis and that are structured to move in the cuts in order to lift up the edges of the rubber plies, the edges of the rubber plies extending axially beyond the bead wires towards ends of the drum, in order to turn over the edges.

20. The equipment according to claim 19, wherein the drum is an expandable drum free of grooves.

21. The equipment according to claim 19, wherein the wings are mounted on a lifting device of the ply-turning device, the lifting device including a driver arranged to move the wings in at least one of: the axial direction and the radial direction.

22. The equipment according to claim 21, wherein the lifting device is independent of the drum.

23. The equipment according to claim 19, wherein the ply-turning device includes a plurality of circumferential articulated arms on which the rollers are mounted, the arms being mounted on the ply-turning device to be moveable radially and axially with respect to the drum.

24. The equipment according to claim 19, wherein the rollers and the wings are mounted on a common support that is moveable in longitudinal translation with respect to the drum and that is secured to a driver structured to move the rollers and the wings in a same direction, but with movement of the rollers being temporally offset from movement of the wings.
